(19) United States
(12) Patent Application Publication
(10) Pub. No.: US 2012/0111520 A1
(43) Pub. Date: May 10, 2012

(54) METHOD FOR THE PREPARATION OF ACID-TOLERANT CALCIUM CARBONATE FILLERS AND FILLED PAPER BASED ON HIGH-LIGNIN-CONTENT DEINKED PULP DERIVED FROM RECYCLED NEWSPAPER

(76) Inventors: Jing SHEN, Harbin (CN); Zhanqian SONG, Nanjing (CN); Xueren QIAN, Harbin (CN); Yu ZHANG, Ningbo (CN)

(21) Appl. No.: 12/941,601

(22) Filed: Nov. 8, 2010

(30) Foreign Application Priority Data
Nov. 4, 2010 (CN) 201010531823.9

(51) Int. Cl. D21H 17/63; C09C 1/02

(52) U.S. Cl. 162/181.9; 106/464; 106/465

(57) ABSTRACT

The present invention relates to a method for the modification of calcium carbonate fillers to improve their acid-tolerant property and to make their effective use in papermaking of high-lignin-content deinked pulp derived from recycled newspaper. It has been found that modification of calcium carbonate fillers using the combination of a calcium salt with a weak acid can improve the acid-tolerant property of the fillers, and the optical properties of the filled paper, such as brightness, can also be effectively improved.

### CROSS REFERENCE TO RELATED PATENT APPLICATIONS

This patent application claims priority from Chinese patent application Serial No. 201010531823.9, filed on Nov. 4, 2010.

### FIELD OF THE INVENTION

The present invention relates to a method for the preparation of acid-tolerant fillers and use of the fillers in high-lignin-content deinked-pulp-containing papers with the feature that filler modification with calcium salt/weak acid can significantly improve the acid-tolerant property of the fillers and optical properties of the filled papers.

### BACKGROUND OF THE INVENTION

Mineral fillers are widely used in the paper industry to reduce manufacturing cost and to improve the critical properties (such as brightness and opacity) of paper products. The fillers suitable for use can include kaolin clay (calcined or hydrous), natural ground calcium carbonate, precipitated calcium carbonate, talc, titanium oxide, silica, calcium silicate, aluminosilicate, alumina trihydrate, precipitated calcium sulphate, sericite, etc, to mention just a few.

Among different types of fillers, calcium carbonate fillers, including ground calcium carbonate (GCC) and precipitated calcium carbonate (PCC), are preferred in many cases due to their low cost and good optical properties. As one category of fillers with alkaline characteristic, calcium carbonate can be effectively used in alkaline papermaking to provide cost savings and optical properties improvement. However, the use of calcium carbonate fillers in high-lignin-content papers was discouraged by the so called “Fiber Alkaline Darkening” effect. Under acidic or pseudo-neutral papermaking conditions, “Fiber Alkaline Darkening” is very low; however, the dissolution of calcium carbonate fillers under such conditions is significant due to their poor acid-tolerant property.

In order to inhibit the “Fiber Alkaline Darkening” effect, to improve the acid-tolerant property of calcium carboante fillers, and to enable the effective use of cost-effective calcium carbonate fillers in high-lignin-content paper grades, various methods have been proposed.

Pakarinen, H. and Leino, H., Wochenblatt für Papierfabrikation, 129, 953-958 (2003) discloses the use of carbon dioxide to adjust the papermaking system containing deinked pulp (containing calcium carbonate) to pseudo neutral, and the benefit of using carbon dioxide in the production of deinked pulp containing newsprint is discussed.

U.S. Pat. No. 6,540,870 discloses the use of carbon dioxide to substantially retard the dissolution of calcium carbonate in a papermaking system.

U.S. Pat. No. 6,540,878 discloses the treatment of calcium carbonate fillers with carbon dioxide for papermaking applications, and the dissolution rate of calcium carbonate is retarded.

U.S. Pat. No. 5,599,388 discloses the treatment of calcium carbonate fillers with aluminum salt (such as aluminum sulfate, aluminum chloride, or polyaluminum chloride), and the modified fillers are acid resistant, which are claimed to be suitable for use in the making of neutral to weakly acid paper.

U.S. Pat. No. 5,043,017 and U.S. Pat. No. 5,156,719 disclose a process for the preparation of acid-tolerant calcium carbonate fillers by the addition to finely divided calcium carbonate of one of a calcium-chelating agent and a conjugate base, such as sodium hexametaphosphate, followed by the addition of a weak acid, such as phosphoric acid. The method for the use of acid-tolerant calcium carbonate fillers in the making of neutral to acidic paper in order to improve the optical properties of the paper is also disclosed. Evans, B. and Slozer, M., 5th International Paper & Coating Symposium 43-46 (2003) discloses the process of adding a weak acid (such as phosphoric acid) continuously to the wet end of a paper machine containing calcium carbonate filler particles and an appropriate chelant/sequestrant (such as sodium hexametaphosphate), and such a process is claimed to be suitable for enabling the effective use of calcium carbonate fillers in groundwood papers.

Shen, J. et al., BioResources, 4(3): 1178-1189 (2009) and Shen et al. China Pulp & Paper, 27(10): 13-17 (2008) disclose the use of sodium silicate, phosphoric acid, and sodium hexameta-phosphate for acid-stabilization of precipitated calcium carbonate filler, and such a filler modification method can improve the use of precipitated calcium carbonate in papermaking of deinked pulp derived from recycled newspaper.

U.S. Pat. No. 5,593,488 discloses an improved form of calcium carbonate which is acid resistant to enable its use as a filler material in the making of neutral to weakly acidic paper, and a process for producing this acid resistant calcium carbonate is provided. This acid resistant calcium carbonate comprises a mixture of at least about 0.1 percent, based on the dry weight of the calcium carbonate, of a weak base together with at least about 0.1 percent, based on the dry weight of the calcium carbonate, of a weak acid.

U.S. Pat. No. 6,228,161 and U.S. Pat. No. 7,033,428 disclose a process for the preparation of acid-stabilized calcium carbonate slurry (suitable for making acid paper) having a pH of less than 7, preferably between about 6 and about 7, containing water, calcium carbonate, preferably precipitated calcium carbonate, and an acid-stabilizer of a water soluble calcium salt, a weak acid, a chelating agent, a weak acid capable of chelating calcium ion, or a mixture thereof. The acid-stabilizer is present in an amount sufficient to provide an aqueous calcium carbonate slurry having an increased calcium ion concentration and an acidic pH. In a typical acid-stabilized calcium carbonate slurry of the invention, the acid-stabilizer is present in an amount sufficient to provide a calcium ion concentration of about 1 millimolar to about 5 molar, preferably from about 1 to about 120 millimolar.

Pang, P., Ph.D Thesis of the University of British Columbia (2001), Pang, P. et al., Industrial & Engineering Chemistry Research, 40: 2445-2451 (2003), Pang, P. and Englezos, P., Pulp and Paper Canada, 104(6): 152-154 (2003), Pang, P. et al., Tappi Journal, 81(4): 188-192 (1998), and Pang, P. et al., Appita Journal, 56(2): 122-126 (2003) disclose the use of phosphoric acid in modification of calcium carbonate fillers to improve their acid-tolerant property and make them more suitable for use in high-lignin-content paper grades.

U.S. Pat. No. 5,913,973 discloses a method for producing a high solids slurry of an acid-resistant precipitated calcium carbonate for shipping purposes, and the acid-resistant calcium carbonate is obtained by such processes as modification with sodium aluminate and a weak acid.

U.S. Pat. No. 6,083,317 discloses an improved form of calcium carbonate which is acid resistant to enable its use as a filler material in the making of neutral to weakly acidic paper. This improved form of calcium carbonate is obtained by modification of calcium carbonate with sodium silicate and one or more weak acids or alum.

U.S. Pat. No. 5,000,791 discloses a process for the preparation of an acid-resistant coating and calcium carbonate particles, in which process a slurry of calcium carbonate particles is mixed simultaneously with the solution of a zinc compound and a solution of a silica-containing substance at a temperature of 70°-95° C., the pH being maintained at 8-11. This invention also relates to the use of calcium carbonate particles having an acid-resistant coating in accordance with the above-mentioned process, as an acid-resistant filler in the production of paper at pH 4.0-7.0.

U.S. Pat. No. 5,164,006 discloses a process for the modification of calcium carbonate fillers with sodium silicate, carbon dioxide, and zinc chloride to prepare acid-resistant calcium carbonate fillers suitable for papermaking applications.

Shen, J. et al., BioResources, 4(4): 1498-1519 discloses the use of sodium silicate, zinc chloride, sodium hexametaphosphate, and phosphoric acid for the acid-stabilisation modification of precipitated calcium carbonate filler, and such a process for filler modification can improve the use of precipitated calcium carbonate filler in papermaking of deinked pulp derived from recycled newspaper.

U.S. Pat. No. 4,174,998 discloses a method for filler preflocculation using a starch phosphate and an organic polymeric retention aid such as a polyacrylamide. The use of a starch phosphate and an organic polymeric retention aid for preflocculation of calcium carbonate fillers can enhance their acid-tolerant property, when used in papermaking.

U.S. Pat. No. 3,873,336 discloses a method for modification of calcium carbonate fillers with a mixture of anionic starch derivative and cationic starch derivative for papermaking application, and such a filler modification process can improve the acid-tolerant property of calcium carbonate fillers.

European Patent No. 2,158,359 discloses a filler modification method for papermaking applications using anionic latex as a modifier, and such a method can improve the acid-tolerant property of calcium carbonate fillers.

There is still a need to improve the acid-tolerant property of calcium carbonate fillers and to improve their use in high-lignin-content paper products.

### SUMMARY OF THE INVENTION

The present invention provides a method for the preparation of acid-tolerant precipitated calcium carbonate fillers and their use in papermaking of deinked pulp derived from recycled newspaper.

It has now been found that the use of calcium salt in combination with a weak acid for the modification of calcium carbonate fillers can improve their acid-tolerant property significantly, and use of the modified fillers in papermaking of high-lignin-content deinked pulp derived from recycled newspaper can significantly improve the optical properties of the paper products.

An embodiment of the present invention provides a process of improving acid tolerance of particulate calcium carbonate used as filler in production of paper from high-lignin-content deinked pulp derived from recycled newspaper, comprising treating the particulate calcium carbonate by mixing the particulate calcium carbonate with a calcium salt in the presence of a weak acid.

More particularly, this invention concerns an acid-tolerant calcium carbonate composition comprising a mixture of calcium carbonate with about 0.1 to about 30 percent, based on the dry weight of the calcium carbonate, of a calcium salt, together with about 0.1 to about 10 percent, based on the dry weight of the calcium carbonate, of a weak acid. The use of said acid-tolerant calcium carbonate fillers can provide more significant improvement in paper brightness in comparison with the unmodified calcium carbonate.

A further understanding of the functional and advantageous aspects of the invention can be realized by reference to the following detailed description.

### DETAILED DESCRIPTION OF THE INVENTION

Generally speaking, the embodiments described herein are directed to methods for the preparation of acid-tolerant fillers and use of the fillers in high-lignin-content deinked-pulp-containing papers. As required, embodiments of the present invention are disclosed herein. However, the disclosed embodiments are merely exemplary, and it should be understood that the invention may be embodied in many various and alternative forms. Some features may be exaggerated or minimized to show details of particular elements while related elements may have been eliminated to prevent obscuring novel aspects.

Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to methods for the preparation of acid-tolerant fillers and use of the fillers in high-lignin-content deinked-pulp-containing papers. As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the coordinating conjunction “and/or” is meant to be a selection between a logical disjunction and a logical conjunction of the adjacent words, phrases, or clauses. Specifically, the phrase “X and/or Y” is meant to be interpreted as “one or both of X and Y” wherein X and Y are any word, phrase, or clause.

As used herein the phrase “increasing acid tolerance” means enabling the particulate fillers to be more resistant to attack by any acids or acidic groups present in an aqueous medium.

As used herein, the phrase “weak acid” means any acids that dissociate incompletely.

The present inventors have discovered that a modification of calcium carbonate fillers with a calcium salt combined with a modification with a weak acid imparts to the calcium carbonate fillers used for papermaking (such as precipitated calcium carbonate) improved acid-tolerant property of the fillers, and the use of the fillers in papermaking of high-lignin-content deinked pulp can be improved correspondingly. In comparison with unmodified calcium carbonate fillers, the modified calcium carbonate fillers modified according to the invention disclosed herein have a high degree of acid-resistance, and paper produced containing the modified calcium carbonate fillers have higher optical properties, such as brightness.

While not wishing to be bound by any particular theory as to the operability of the present invention, it is believed that the combination of a calcium salt and a weak acid can inactivate the surface of calcium carbonate fillers for papermaking applications, and the modifiers can also form a highly buffered system to confer a high degree of acid-resistance to the calcium carbonate fillers.

The calcium carbonate fillers utilized are preferably finely divided and they can be either precipitated calcium carbonate or natural ground calcium carbonate. They can be utilized either as a powder or an aqueous slurry with a solids content of 10% to 60%.

In a first embodiment of the present invention, the calcium salt is present in a sufficient amount to provide a highly buffered system and/or sufficient surface inactivation of the calcium carbonate, and the amount can be in the range from about 0.1 to about 30 percent, based on the dry weight of the calcium carbonate, preferably from about 0.5 to about 10 percent, based on the dry weight of the calcium carbonate. The calcium salt utilized in the compositions of the present invention can be any form of calcium salt available as commercial product, such as calcium sulfate, calcium acetate, calcium nitrate, calcium citrate, a calcium halide, e.g., calcium chloride, and mixtures thereof to mention just a few.

In a second embodiment of the present invention, the weak acid is present in a sufficient amount to provide a highly buffered system and/or sufficient surface inactivation of the calcium carbonate, and the amount can be in a range from about 0.1 to about 10 percent, based on the dry weight of the calcium carbonate, preferably from about 1 to about 6 percent, based on the dry weight of the calcium carbonate. The weak acid utilized in the compositions of the present invention can be any form of weak acid available as commercial product, such as, but not limited to carbonic acid, phosphoric acid, sulfurous acid, or a carboxylic acid, where the carbonic acid is typically provided by the addition of carbon dioxide.

In a third embodiment of the present invention, the acid-stabilization modification with calcium salt and weak acid can be carried out by adding the calcium salt and weak acid either simultaneously or sequentially to the calcium carbonate. The two modifiers (calcium salt and weak acid) can be either added in the form of dry powders or in the form of water solutions. If the two modifiers (calcium salt and weak acid) are added to calcium carbonate sequentially, the addition of calcium salt can be followed immediately by the addition of weak acid or the addition of weak acid can be followed immediately by the addition of calcium salt; there can be also be a time delay between the addition of the calcium salt and the weak acid or vice versa. The time delay can be carefully adjusted to suit specific applications.

In a fourth embodiment of the present invention, the filler modification process can be carried out at temperatures of 0° C. to 100° C., preferably 10° C. to 50° C.

In an additional embodiment of the present invention, the filler modification process can be carried out under different air pressures, and the selection of the suitable pressure is dependent upon the specific modifiers used. When carbon dioxide is used as the weak acid, the modification process can be carried out under either ambient pressure or elevated pressure, depending the operational viability of the process.

In a further embodiment of the present invention, the filler modification process can be carried out during the manufacturing and/or processing process of calcium carbonate fillers. The filler modification process can be carried out on the precipitated calcium carbonate and ground calcium carbonate at the plants where the calcium carbonate is produced. The filler modification can be combined with the manufacturing and/or processing of the calcium carbonate fillers to provide lowered costs.

The present invention also relates to a method of forming a filled paper with the papermaking raw materials based on high-lignin-content deinked pulp derived from recycled newspaper. The papermaking process can be carried out by adding the modified calcium carbonate to the well dispersed pulp followed by draining the furnish on the papermaking wire, pressing, and drying, calendering, etc. The present invention also relates to the process for the use of modified calcium carbonate in acidic or pseudo-neutral papermaking, where the “Fiber Alkaline Darkening” effect of the high-lignin-content pulp can be minimized, resulting in the production of paper products with higher brightness in comparison to the use of unmodified calcium carbonate fillers.

The invention will be further illustrated by the following Examples, which are to be considered illustrative of the invention, and not limited to the embodiments shown.

### Example 1

This example demonstrates the effect of the addition of a calcium salt on the pH of a 5 percent calcium carbonate slurry at a pressure of one atmosphere. Calcium chloride solution (with the added amount of 1%, based on the dry weight of the calcium carbonate) was added to the precipitated calcium carbonate slurry containing 10 g precipitated calcium carbonate, to make the total weight of the resultant slurry 200 g. After 24 hours aging and 48 hours aging, the pH values of unmodified precipitated calcium carbonate slurry with precipitated calcium carbonate content of 5 percent were 10.06 and 10.15, respectively. After 24 hours and 48 hours aging, the pH values of modified precipitated calcium carbonate slurry with precipitated calcium carbonate content of 5 percent were 9.01 and 9.57. The addition of calcium chloride suppressed the dissolution of precipitated calcium carbonate filler, resulting in decreased system pH.

### Example 2

This example demonstrates the effect of the addition of a calcium salt and a weak acid on the pH of a 5 percent calcium carbonate slurry at a pressure of one atmosphere. Calcium chloride solution and phosphoric acid solution are sequentially added to the precipitated calcium carbonate slurry containing 10 g precipitated calcium carbonate, to make the total weight of the resultant slurry 200 g. The pH values of filler slurries, with precipitated calcium carbonate content of 5 percent, after 24 hours aging and 48 hours aging are shown in Table 1.

TABLE 1

| | Amount of | | | |
|---|---|---|---|---|
| | calcium | Amount of | pH of the | pH of the |
| | chloride | phosphoric | slurry after 24 | slurry after 48 |
| Sample | (%) | acid (%) | hours aging | hours aging |
| Unmodified | — | — | 10.06 | 10.15 |
| precipitated | | | | |
| calcium | | | | |
| carbonate | | | | |
| Modified | 1 | — | 9.01 | 9.57 |
| precipitated | | | | |
| calcium | | | | |
| carbonate | | | | |
| Modified | 1 | 0.5 | 7.86 | 8.08 |
| precipitated | | | | |
| calcium | | | | |
| carbonate | | | | |
| Modified | 1 | 1 | 7.21 | 7.52 |
| precipitated | | | | |
| calcium | | | | |
| carbonate | | | | |
| Modified | 1 | 2 | 7.15 | 7.45 |
| precipitated | | | | |
| calcium | | | | |
| carbonate | | | | |
| Modified | 1 | 3 | 6.86 | 6.99 |
| precipitated | | | | |
| calcium | | | | |
| carbonate | | | | |
| Modified | 1 | 4 | 6.45 | 6.69 |
| precipitated | | | | |
| calcium | | | | |
| carbonate | | | | |

The results show that the use of calcium chloride/phosphoric acid for the modification of precipitated calcium carbonate can effectively decrease the dissolution of precipitated calcium carbonate in aqueous medium.

### Example 3

This example demonstrates the alum consumption values of modified precipitated calcium carbonate filler prepared using calcium chloride and phosphoric acid with added amounts of 1% and 4%, respectively, based on the dry weight of the calcium carbonate. For the measurement of the acid-tolerant property of calcium carbonate fillers, the alum consumption method mentioned in several publications such as U.S. Pat. No. 5,000,791, U.S. Pat. No. 5,164,006, (which are both incorporated herein by reference in their entirety) and Jaakkola, P. and Mannu, H., Nordic Pulp and Paper Research Journal, 16: 113-117 (2001) was used. For the alum consumption method, a 4% alum solution was freshly prepared and added to a 40 mL sample of modified precipitated calcium carbonate filler slurry at a pace that maintained the pH at 6.50, and the consumption of alum solution was measured. The alum consumption values of modified filler and unmodified filler at different times are shown in Table 2 and Table 3, respectively.

The results demonstrate that filler modification with using calcium chloride and phosphoric acid with added amounts of 1% and 4%, respectively, based on the dry weight of the calcium carbonate, can reduce the alum consumption. From Example 2 and Example 3, it can be concluded that, filler modification with calcium chloride and phosphoric acid can improve the acid-tolerant property of the calcium carbonate. The results can well support the embodiments of the patent.

TABLE 2

| Time (min) | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| Alum Consumption (mL) | 0.3 | 0.4 | 0.5 | 0.5 | 0.6 | 0.7 | 0.8 | 0.9 | 1.1 | 1.4 | 1.9 | 2.5 | 2.8 | 3.1 | 3.4 |

TABLE 3

| Time (min) | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| Alum Consumption (mL) | 1.6 | 2.0 | 2.5 | 2.8 | 3.0 | 3.1 | 3.2 | 3.3 | 3.6 | 3.9 | 4.2 | 4.5 | 4.9 | 5.2 | 5.5 |

### Example 4

This example demonstrates the effect of acid-tolerant fillers on the optical properties of the filled paper. When the added amounts of calcium chloride and phosphoric acid were 1% and 4%, respectively, the resultant modified precipitated calcium carbonate was used as filler material for handsheet preparation, and high lignin-content deinked pulp derived from recycled newspaper was used. The procedure for handsheet preparation was reported by Shen, J., BioResources, 4(3): 1178-1189 (2009), which is now re-shown as follows:

The mixture of pulp and filler was diluted to 0.5%, and the target filler is loading level was controlled to be 15 wt %. Cationic polyacrylamide solution was added, and the slurry was stirred for 1 min. Diluted alum solution was then added dropwise to adjust the slurry pH to 6.50, and the pH-adjusting time was controlled to be 1 min. Handsheets with target basis weight of 60 g/m² were then prepared using the sheet former (ZQJ1-B200 mm) produced in China. The handsheets were further pressed and flattened for 24 h using the apparatus equipped with the sheet former. The conditions for handsheet preparation were kept consistent for all of the samples.

The optical properties of the unfilled handsheets, unmodified precipitated calcium carbonate filled handsheets, and modified precipitated calcium carbonate filled handsheets are show in Table 4.

It can be seen from Table 4 that filler modification with calcium chloride and phosphoric acid significantly improved the brightness of the filled paper.

TABLE 4

| | Brightness |
|---|---|
| Sample | (% ISO) |
| Unfilled handsheets | 61.7 |
| Handsheets filled with unmodified filler | 67.8 |
| Handsheets filled with modified filler | 71.1 |

As used herein, the terms “about” and “approximately”, when used in conjunction with ranges of dimensions of particles, compositions of mixtures or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

The foregoing description of the preferred embodiments of the invention has been presented to illustrate the principles of the invention and not to limit the invention to the particular embodiment illustrated. It is intended that the scope of the invention be defined by all of the embodiment encompassed within the following claims and their equivalents.

### REFERENCES

1. Pakarinen, H., and Leino, H. (2001). “Benefits of using carbon dioxide in the production of DIP containing newsprint,” Wochenblatt für Papierfabrikation 129, 953-958.

2. Laurila-Lumme, A., Pakarinen, H., and Leino, H. J. (2003). “Process for substantially retarding dissolution of calcium carbonate in a papermaking system,” U.S. Pat. No. 6,540,870, April 1.

3. Leino, H. J. (2003). “Stabilized filler, its production and use,” U.S. Pat. No. 6,540,878, April 1.

4. Wu, K. T. (1997). “Acid resistant calcium carbonate composition containing an aluminum salt, uses therefor and processes for its production,” U.S. Pat. No. 5,599,388, February 4.

5. Passarefti, J. D. (1991). “Acid-stabilized calcium carbonate, process for its production and method for its use in the manufacture of acidic paper,” U.S. Pat. No. 5,043,017, August 27.

6. Passaretti, J. D. (1991). “Acid-stabilized calcium carbonate, process for its production and method for its use in the manufacture of acidic paper,” U.S. Pat. No. 5,156,719, October 20.

7. Evans, B., and Slozer, M. (2003). “Neutral groundwood papers: Practical and chemical aspects,” International Paper & Coating Symposium.

8. Shen, J., Song, Z., Qian, X., and Liu, W. (2009). “A preliminary investigation into the use of acid-tolerant precipitated calcium carbonate fillers in papermaking of deinked pulp derived from recycled newspaper,” BioResources 4(3), 1178-1189.

9. Shen, J., Song, Z. Q., Qian, X. R., Wang, K. C., and Zhang, Y. (2008). “Dissolution-inhibiting effect of silicate-based inhibitors on precipitated calcium carbonate filler,” China Pulp & Paper 27(10), 13-17.

10. Wu, K. T. (1997). “Acid resistant calcium carbonate composition and uses therefor,” U.S. Pat. No. 5,593,488, January 14.

11. Drummond, D. K. (2001). “Use of calcium carbonate in acidic aqueous medium,” U.S. Pat. No. 6,228,161, May 8.

12. Drummond, D. K. (2006). “Acid stabilized calcium carbonate and method of making it,” U.S. Pat. No. 7,033,428, April 25.

13. Pang, P. (2001). “Optimization of the use of polyethylene oxide and calcium carbonate in papermaking,” Ph.D Thesis of the University of British Columbia.

14. Pang, P., Deslandes, Y., Raymond, S., Pleizier, G., and Englezos, P. (2001). “Surface analysis of ground calcium carbonate filler treated with dissolution inhibitor,” Industrial & Engineering Chemistry Research 40, 2445-2451.

15. Pang, P., and Englezos, P. (2003). “Application of pretreated ground calcium carbonate in mechanical pulp suspension,” Pulp and Paper Canada 104(6), 152-154.

16. Pang, P., Khoultchaev, K. K., and Englezos, P. (1998). “inhibition of the dissolution of papermaking grade precipitated calcium carbonate filler,” Tappi Journal 81(4), 188-192.

17. Pang, P., Modgi, S. B., and Englezos, P. (2003). “Optimisation of the use of calcium carbonate as filler in mechanical pulp,” Appita Journal 56(2), 122-126.

18. Rodriguez, J. M., and Fortier, S. M. (1999). “Method for producing high solids aqueous acid-resistant calcium carbonate suspensions and product thereof,” U.S. Pat. No. 5,913,973, June 22.

19. Snowden, K. J., Wu, K. T., and Rodriguez, J. M. (2000). “Stabilized calcium carbonate composition using sodium silicate and one or more weak acids or alum and uses therefor,” U.S. Pat. No. 6,083,317, Jul. 4.

20. Tokarz, M., Jaras, S., and Sikkar, R. (1991). “Process for the preparation of an acid-resistant coating on filler particles,” U.S. Pat. No. 5,000,791, March 19.

21. Chapnerkar, V. D., Lasmarias, V. B., and Mathur, V. K. (1992). “Method for preparing acid resistant calcium carbonate pigments,” U.S. Pat. No. 5,164,006, November 17.

22. Shen, J., Song, Z., Qian, X., and Liu, W. (2009). “Modification of precipitated calcium carbonate filler using sodium silicate/zinc chloride based modifiers to improve acid-resistance and use of the modified filler in papermaking,” BioResources 4(4), 1498-1519.

23. Shiel, L. E. (1979). Preflocculated filler compositions for use in the manufacture of paper. U.S. Pat. No. 4,174,998, November 20.

24. Lambert, B. P., and Lowes, J. A method for treating calcium carbonate paper filler. U.S. Pat. No. 3,873,336, March 26.

25, Laleg, M., Collins, R., Gagne, 0, Middleton, S. Latex-treated filler slurries for use in papermaking. European Patent 2,158,359, March 13.

26. Jaakkola, P., and Mannu, H. (2001). “Comparisons of methods for stabilization of PCC against dissolution at acid papermaking conditions,” Nordic Pulp and Paper Research Journal 16, 113-117.

Therefore what is claimed is:

1. A process of improving acid tolerance of particulate calcium carbonate used as filler in production of paper from high-lignin-content deinked pulp derived from recycled newspaper, comprising treating the particulate calcium carbonate by mixing the particulate calcium carbonate with a calcium salt in the presence of a weak acid.

2. The process according to claim 1 wherein the calcium salt is selected from the group consisting of calcium sulfate, calcium acetate, calcium nitrate, calcium citrate, a calcium halide, and mixtures thereof.

3. The process according to claim 2 wherein the calcium halide is calcium chloride.

4. The process according to claim 1 wherein the weak acid is selected from the group consisting of carbonic acid, phosphoric acid, sulfurous acid, citric acid, acetic acid, oxalic acid, a carboxylic acid, and mixtures thereof, and wherein the carbonic acid is provided by addition of carbon dioxide to the particulate calcium carbonate.

5. The process according to claim 1 wherein the calcium salt is present in an amount in a range from about 0.1 to about 30 percent, based on the dry weight of the calcium carbonate.

6. The process according to claim 1 wherein the calcium salt is present in an amount in a range from about 0.5 to about 10 percent, based on the dry weight of the calcium carbonate.

7. The process according to claim 1 wherein the weak acid is present in an amount in a range from about 0.1 to about 10 percent, based on the dry weight of the calcium carbonate.

8. The process according to claim 1 wherein the calcium salt and the weak acid are added to the particulate calcium carbonate either simultaneously or sequentially to the calcium carbonate.

9. The process according to claim 1 wherein the calcium salt is selected from the group consisting of calcium sulfate, calcium acetate, calcium nitrate, calcium citrate, a calcium halide, and mixtures thereof.

10. The process according to claim 9 wherein the calcium halide is calcium chloride, and mixtures thereof.

11. The process according to claim 9 wherein the calcium salt and the weak acid are added to the particulate calcium carbonate in the form of dry powders or in the form of aqueous solutions.

12. The process according to claim 1 wherein the calcium salt and the weak acid are added to the particulate calcium carbonate sequentially, and wherein weak acid is added first followed by the addition of the calcium salt.

13. The process according to claim 1 wherein the calcium salt and the weak acid are added to the particulate calcium carbonate sequentially, and wherein calcium salt is added first followed by the addition of the weak acid.

14. The process according to claim 1 wherein the calcium salt and the weak acid are added to the particulate calcium carbonate at the same time.

15. The process according to claim 1 wherein the calcium salt and the weak acid are mixed with the particulate calcium carbonate in a solution at a temperature in a range from about 0° C. to about 100° C.

16. The process according to claim 1 wherein the calcium salt and the weak acid are mixed with the particulate calcium carbonate in a solution at a temperature in a range from about 10° C. to about 50° C.

17. A paper product, produced from high-lignin-content deinked pulp derived from recycled newspaper, incorporating particulate calcium carbonate filler which has been modified according to the method of claim 1.
